(19) United States
(12) Patent Application Publication
(10) Pub. No.: US 2010/0047425 A1
(43) Pub. Date: Feb. 25, 2010

(54) Scoop Cutter and Method for Producing Shaped Food Products

(75) Inventors: Daniel Eugene ORR, Dallas, TX (US); John Michael PENNINGTON, Hickory Creek, TX (US)

Correspondence Address: CARSTENS & CAHOON, LLP, P O BOX 802334, DALLAS, TX, 75380, US

(73) Assignee: FRITO-LAY NORTH AMERICA, INC., Plano, TX (US)

(21) Appl. No.: 12/194,114

(22) Filed: Aug. 19, 2008

(51) Int. Cl. A23L 1/00; A23P 1/10; A21D 6/00

(52) U.S. Cl. 426/531; 426/516; 426/503; 425/276

(57) ABSTRACT

A scoop cutter and method for producing shaped food products. A rotating arcuate blade with a cutting edge on at least one side works in conjunction with a thickness spacing sphere to produce a shaped food product having three dimensions. As food product in the form of non-sticky, low tact dough, or raw or whole fruits and vegetables comes into contact with the thickness spacing sphere, the blade slices it, creating shaped food products with uniform thickness. The width to depth ratio of the shaped food product is adjustable depending on the desired texture and size.

### BACKGROUND OF THE INVENTION

1. Technical Field

The present invention relates to a novel scoop cutter apparatus, designed to produce arcuate shaped, three-dimensional food products. The invention allows for continuous production of shaped snack food products having a consistent thickness, which can be adjusted to produce a desired texture and size through the variation of the widths and/or depths of the snack products.

2. Description of Related Art

Various machines and systems have been created for the commercial production of food products, such as snack chips, to produce chips and crackers having a variety of textures, shapes, and sizes to appeal to the different preferences of consumers. A wide range of methods for slicing food products as a pre-processing step to produce any number of snack chips shapes are known in the industry. Often, product shapes are merely ornamental in design to assume an interesting shape that appeals to consumers. Sometimes, snack product shapes assume a utilitarian function such as, for example, the retention of liquid mixtures such as dip, salsa, bean dip, cheese dip, sour cream dip and the like. Shaped snack chips allow the consumer to scoop up a desired portion of dip without losing a significant quantity during transfer to the mouth for eating. Utilitarian shapes used with food products include ridged-shapes, taco-shapes, spoon-shapes, and scoop (or bowl)-shapes. Of these, a scoop-shaped chip is particularly desirable as it has a retaining wall or edge surrounding the perimeter of the chip.

Current methods for producing utilitarian shapes involve specialized blades. Existing blade technology utilizes serrated or ridged blades to produce either flat-shaped snack food products or strips. While this provides for different textures to food products, the blades remain generally elongated and straight, and are unable to produce the three-dimensional, scoop-shaped food products often desired by consumers.

Methods for the production of scoop-shaped food products currently apply only to dough-based fabricated snack food products such as tortilla chips. These methods typically begin with the formation of a dough made of a cornmeal or masa, followed by extrusion and sheeting steps. Subsequently, the flat sheets are sliced to create flat-shaped products which must undergo a shaping step in order to attain the three-dimensional form desired. The shaping step typically involves specialized molds or mold cavities in which product may be concurrently baked or fried. These methods are tedious and time-consuming, often requiring exact alignment of flat-shaped products with the specialized molds or cavities in a precisely-run assembly-type process. Further, they are limited to food products formulated from dough and because the molds are specialized, it is difficult and costly to vary the size and/or depth of the snack food products produced without creating other specialized molds having other depths. Moreover, the use of molds can negatively impact the product throughput.

Consequently, it is an object of the present invention to provide for a novel cutting system that provides more variety of shapes and textures for the creation of food products such as ready-to-eat snack products or partially fried, frozen appetizers. In particular, there is a need to provide a method and corresponding apparatus which facilitates the slicing of raw and/or whole food products such as fruits and vegetables, in addition to dough-based foods, enhancing the three-dimensional food product shape most appealing to consumers. Further, there is a need for blade technology capable of consistently producing desirable scoop-shaped food products uniformly. Further still, it is desirable that such an apparatus be capable of adjusting the depth and size of the snack food products to produce a wide variety of textures and levels of crunchiness. There is also a need to provide slicing equipment capable of operating at a high production capacity. Such a process should be capable of producing shaped snack chips while keeping the costs associated with the chip manufacturing equipment and production within industry standards.

### SUMMARY OF THE INVENTION

The present invention provides a novel cutting blade apparatus capable of producing shaped snack food products made from fruits, vegetables and dough. More particularly, a scoop cutter is comprised of an arcuate (ie, curved) blade that can rotate around a thickness spacing sphere. The blade comprises a cutting edge on at least one side such that as a food product comes into contact with the sphere, the blade slices the food product to produce a three-dimensional food product. The scoop cutter has a cutter inner radius extending from the interior of said blade to the center of the sphere, which is one factor in determining the depths of the shaped food products. By adjusting the diameter, a number of different depths for the shaped food products are achieved. The thickness and depth of the product is set by the distance between the surface of the spacing sphere and the interior of the outer curved blade to allow for consistent thickness of the cut. The thickness can be adjusted by using a spacing sphere of another size or a blade having a different curvature.

The method of the present invention comprises forcing at least one food product against a thickness spacing sphere having an outer periphery, wherein said outer periphery is in spaced relation to an arcuate blade, causing the blade to rotate about said outer periphery. As food product comes into contact with the thickness spacing sphere, the food product remains in place while the rotating curved blade slices the food product, producing scoop-shaped food products.

In one embodiment, at least one food product is placed through a feed tube. Thereafter, the food can be forced through the tube and against the sphere by any means known in the art. The diameter of the feed tube is less than or equal to the arc of the blade length of the scoop cutter, to provide for a maximum width of the food product produced. The width to depth ratio of the resulting food product can be adjusted depending upon the desired size and texture.

Other aspects, embodiments and features of the invention will become apparent from the following detailed description of the invention when considered in conjunction with the accompanying drawings. The accompanying figures are schematic and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention, itself, however, as well a preferred mode of use, further objectives and advantages thereof, will be best understood by reference to the following details description of illustrative embodiments when read in conjunction with the accompanying drawings, wherein:

FIG. 1 is a perspective view of one embodiment of the present invention.

FIG. 2 depicts an advancing cylinder and feed tube for use with the novel cutting apparatus in one embodiment of the present invention.

FIG. 3 illustrates a cross-sectional view of one embodiment of the present invention.

FIG. 4 is a perspective view of one embodiment of the novel scoop cutter of the present invention.

FIG. 5 illustrates a front view of one embodiment of the novel scoop cutter apparatus.

FIG. 6 is a detailed view of the adjustable features of one embodiment of the novel scoop cutter of the present invention.

FIG. 7 depicts the sliced products produced in one embodiment of the scoop cutter apparatus of the present invention.

### DETAILED DESCRIPTION

A novel scoop cutter apparatus is comprised of an arcuate blade secured to a thickness spacing sphere having an outer periphery a thickness spacing sphere and an arcuate blade, wherein the blade is caused to rotate around the sphere, thereby slicing any food product that comes into contact with the sphere. The rotating curved blade creates a two-dimensional sliced food product, while the sphere within the rotating curved blade delivers a third dimension to the food product.

As used herein, the term “food product” is meant to include any form of nutrition ingested to produce energy and/or nourishment to sustain life; in particular, fruit, vegetable, or non-sticky, low tact dough able to retain shape when sliced without further mechanical support. Fruits or vegetables may be used either in whole or in part, including without limitation potatoes, apples, sweet potatoes, pears, yams, beets, yucca, watermelon, etc. Dough can be used to create pellets to be either puffed or stored for later processing. Thus, one skilled in the art, armed with this disclosure, will appreciate that the present invention can be used with any fruit, vegetable or dough comprising the ability to retain a given shape upon cutting to create a three-dimensional snack food or appetizer having a retaining wall or edge surrounding the perimeter of the chip.

“Scoop-shaped” or “bowl-shaped” refers to a cup-shaped or semi-spherical body forming a bowl or scoop and at least one axis of symmetry. “Semi-spherical” means less than a complete sphere or less than a complete oval. The term “scoop shaped food product” is meant to mean a food product, as defined above, comprising a curved body having three dimensions with an open side defined by a circumferential curvilinear edge. The shape provides a consumer with the option of dipping or filling a food product while also providing for different types of textures.

The term “thickness spacing sphere” refers to a sphere made of a metal, hard plastic, polymer (including but not limited to ultra high molecular weight polyethylene) or any combination thereof. The sphere comprises a radius, which determines the thickness and/or depth of a snack food product when used in conjunction with an arcuate blade that surrounds the outer periphery of the sphere.

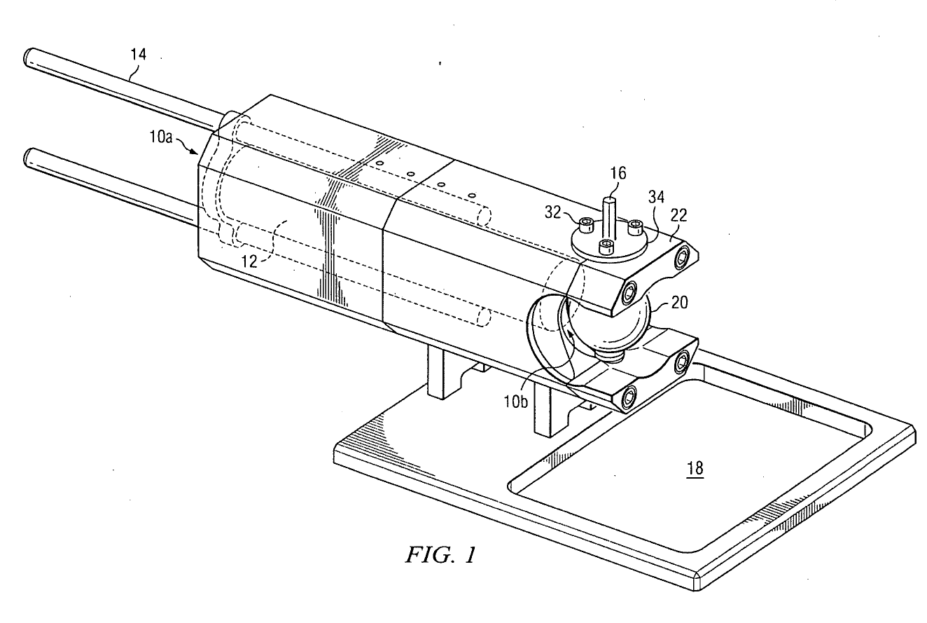

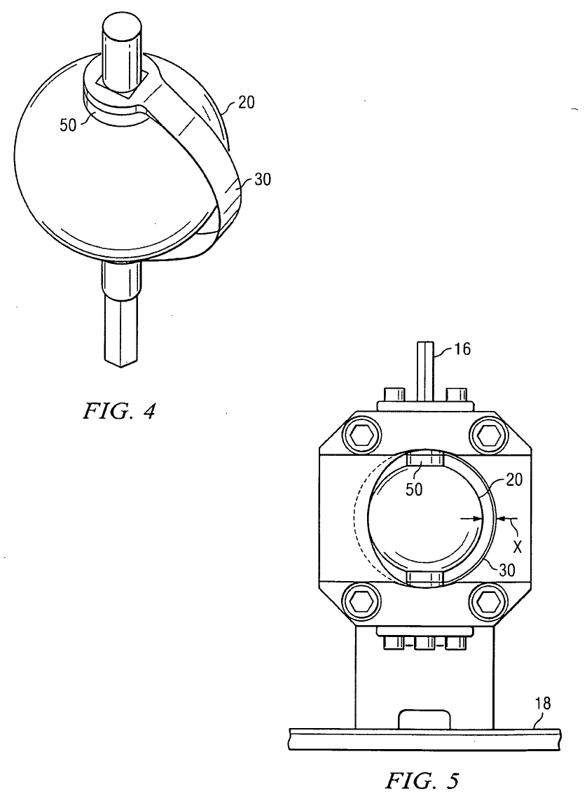

FIGS. 1-6 depict one embodiment wherein the novel cutting apparatus of the present invention is illustrated. Referring to FIGS. 1-3, a feed tube 10 having an entrance end 10a and an outlet end 10b is used to align food product correctly with the scoop cutter. The feed tube 10 is positioned at a non-parallel orientation to an axis of rotation of a thickness spacing sphere 20. The first, entrance end 10a, allows for insertion of food product to be sliced, while the second, outlet end 10b, is adjacent to a scoop cutter of the present invention. In one embodiment, the outlet end 10b contains both the scoop cutting mechanism of the present invention as well as removable end portions 22 adjacent to the exit end 10b and directly above and below the scoop cutter of the present invention. The removable end portions 22 allow for retention of the scoop cutter with bolts 32 which connect through an attachment piece 34 to both the feed tube 10 and the removable portions 22. The ability to remove end portions 22 allows for replacement of either the thickness spacing sphere 20 or the blade 30 as it wears out over time by simply removing bolts 32 to dismantle the scoop cutter.

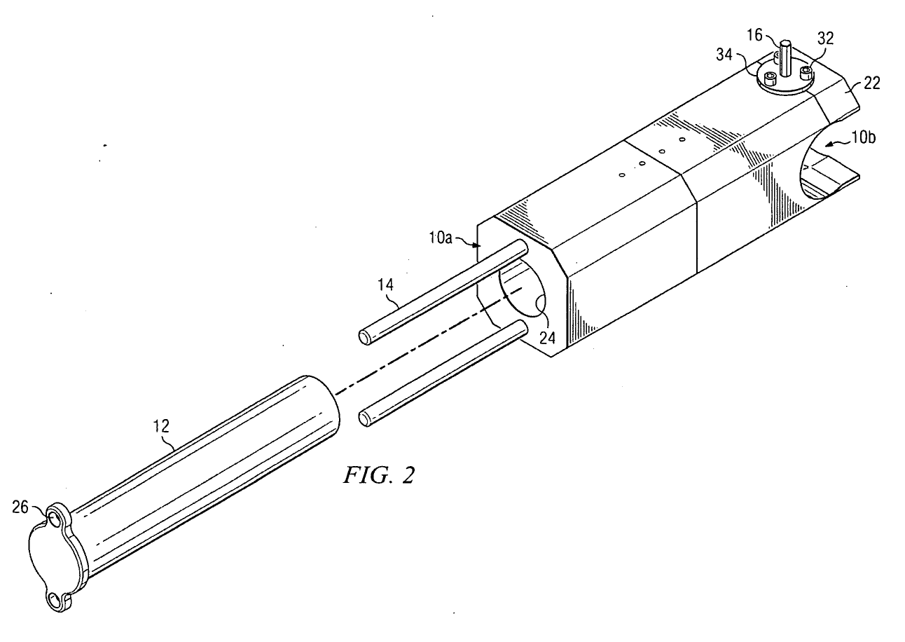

The feed tube 10 allows for the receipt and transfer of at least one food product to be sliced, while providing support to the product during operation of the scoop cutter. However, one skilled in the art, armed with this disclosure, will recognize that a feed chute, funnel, extruder or any other means for receiving food product and having an outlet end adjacent to a scoop cutter can be used in place of the feed tube 10. To obtain a desired width for a snack food product, the outlet end comprises a diameter or other means for measurement including without limitation a radius, length or height. As best depicted in FIGS. 1 and 2, food product is placed into the feed tube 10 through the opening 24 at the entrance end 10a. Food product is forced against the thickness spacing sphere 20 by any means known in the art including but not limited to gravity, rotary advancing augers, parallel advancing conveyors, or pressure via any number of methods including without limitation extrusion, water pressure, etc. One embodiment comprises a cylinder (also referred to as an “advancing cylinder”) 12 to force said at least one food product through a first end in the feed tube 10, thereby causing said food product to come into contact with said thickness spacing sphere 20.

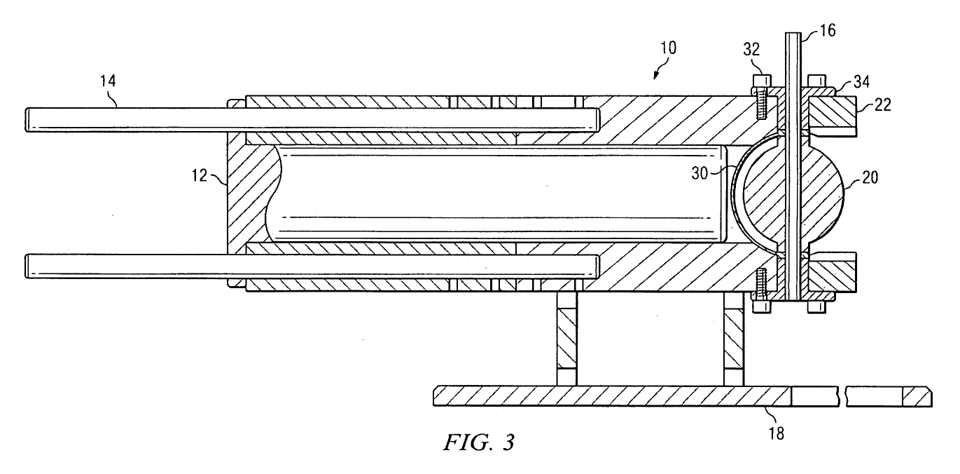

To assist with the advancement of the cylinder 12, one embodiment comprises rods 14, which extend through holes 26 of the cylinder 12 and are positioned parallel to the axis of the feed tube 10, extending along both the interior and exterior of the feed tube 10. By way of example, each of the rods 14 has a diameter of between about 0.1 to 0.9 inches, and more preferably, about 0.5 inches. The rods 14 are also spaced approximately 2 to 4 inches apart, and more preferably 3 inches, to accommodate an advancing cylinder 12 of between about 1 to 3 inches in diameter, and more preferably 2 inches. As best shown in FIGS. 1 and 3, as the advancing cylinder 12 moves forward into the interior of the feed tube 10, the food product within the feed tube 10 is pushed against the thickness spacing sphere 20. Thereafter, the blade 30 is rotated about the outer periphery of the sphere 20 to slice the food product, as further discussed below, resulting in a scoop-shaped food product.

Having discussed one way of operating the scoop cutter of the present invention, the scoop cutter itself will now be described. FIGS. 3-5 illustrate one embodiment of the scoop cutter of the present invention. The cutting apparatus is comprised of an arcuate blade 30 secured to a thickness spacing sphere 20 having an outer periphery, wherein the arcuate blade 30 is in spaced relation to the outer periphery of the sphere and wherein the blade 30 can rotate about the periphery. Both the spacing sphere 20 and the arcuate blade 30 are removable attached to a drive shaft 16, which is connected to a rotational motor device (not shown). In one embodiment, the sphere 20 contains openings that extend through its diameter, creating a passageway along its diameter and through top and bottom spacers 50 of the sphere. The drive shaft 16 passes through the passageway and extends beyond the diameter of the sphere 20 and beyond the spacers 50, creating an axis of rotation and connecting the sphere 20 to a motor device (not shown). The spacers 50 may be integral to the sphere or machined separately and removably secured to the scoop cutter in between the sphere 20 and the cutting blade 30. The arcuate blade 30 attaches to the drive shaft 16 at points outside the outer periphery of the sphere 20 and the spacers 50 by means of holes on either end of the arcuate blade 30 through which the drive shaft 16 passes. As a motor (not shown) causes rotation of the sphere 20 and arcuate blade 30, the blade 30 spins about the outer periphery of the spacing sphere 20 and slices any food product that comes into contact with the sphere 20. In one embodiment, the blade 30 conforms to the shape of the sphere to form a semi-circular blade that can rotate about the outer periphery of the thickness spacing sphere 20. It will be appreciated that the positioning of the food product and the rotation of the sphere and/or blade need not occur at different times but instead can be performed simultaneously in a continuous process without any interruption.

The rotation of the sphere 20 assists in ejecting sliced arcuate food product. As shown in FIGS. 1 and 3, in one embodiment, the sliced product is ejected through an opening 18 in a mounting base, which provides a point for securing or clamping the cutter to a permanent fixture for stability. In an alternate embodiment, multiple cutters are aligned with vertical feed cylinders and the sliced arcuate food product ejects from the cutter to any means known in the art for transferring the product including without limitation a conveyor or water flume for further processing. Thus, one skilled in the art, armed with this disclosure, will recognize that more than one scoop cutter of the present invention can be attached to the same drive shaft; thereby, mounting a plurality of scoop cutters onto either a horizontal or vertical plane to run off the same shaft for higher rates of production. Processing, for example, can include cooking methods such as frying or baking, followed by seasoning and/or salting as desired prior to packaging for consumption of a ready-to-eat snack. Alternatively, processing can include blanching, drying, partially frying (par-frying) and quick freezing to create a par-fried frozen appetizer for later consumption by finish frying.

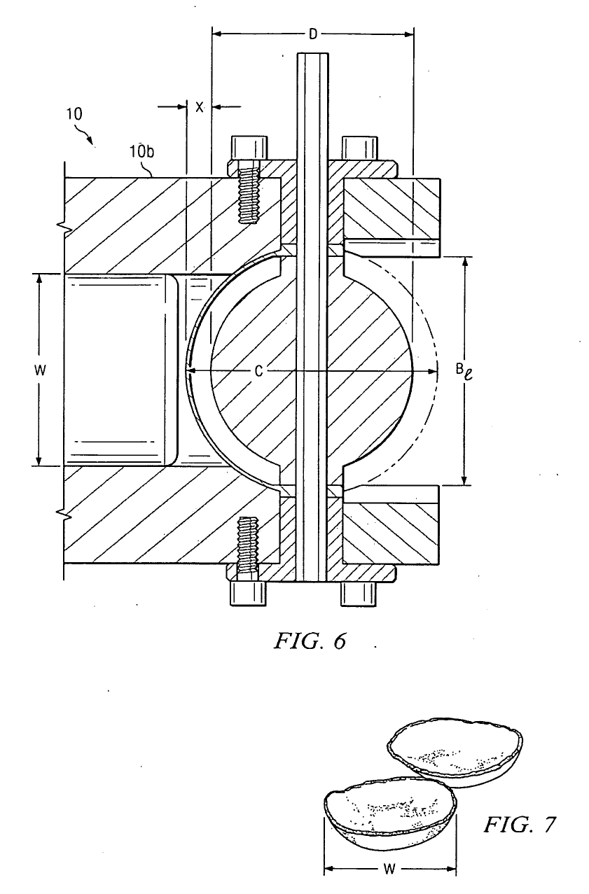

One skilled in the art, armed with this disclosure, will appreciate that the distance x from the interior of the blade 30 to the surface of the sphere 20, as best seen in FIGS. 5-6, will determine the thickness and depth of the slice produced. It will be appreciated that the size of the sphere and arc of the blade may be increased or decreased without materially affecting the scoop cutter. A gap thickness (x), and therefore slice thickness, can be changed by positioning the blade closer to the surface of the sphere or by replacing the sphere with another sphere having a different diameter to position the surface of the sphere either closer to or further from the blade. For example, if a sphere having a diameter of 2.00 is replaced by one having a diameter of 2.125 inches such that the outer periphery is positioned closer to the blade, this would result in a smaller product slice thickness. Suitable diameter sizes fall within the range of up to 5 inches, or more preferably about 1 to 4 inches. One skilled in the art, armed with this disclosure, will realize that larger diameters are also possible, depending on the desired size and texture of a product to be sliced. Different food products will produce different tastes and textures and may require a different slice thickness defined by the distance (x) between the blade and the sphere to satisfy a broad range of consumer preferences. Thus, the sphere 20 is interchangeable and may be substituted with a sphere having another diameter depending on the desired thickness and/or depth of the food product slice. Likewise, the blade 30 can be replaced with a new blade having the same arcuate shape or another blade comprising another curvature, which allows for a greater or lesser cutter inner diameter. In one embodiment, the diameter of the outlet end 10b of the feed tube 10 will limit the size of the product inserted and therefore, will determine a maximum width of the slice attained, while the inner cutter radius of the sphere will determine its maximum depth as well as its thickness. Consequently, the width to depth ratio of a slice produced is adjustable depending on the desired texture and size.

FIG. 6 details the possible adjustment mechanisms of one embodiment of the scoop cutter invention. A feed tube 10 with an outlet end 10b having a diameter (w), which is less than the inner cutter diameter (c) is used in conjunction with a thickness spacing sphere having a diameter (d). The outer periphery or surface of the sphere is spaced at a distance (x). By way of illustration and without limiting Applicants' invention, a sphere comprises a diameter (d) of about 2.125 inches and an outer periphery in spaced relation to the cutting blade at distance (x) of about 0.188 inches. A cutter inner diameter (c), which represents the diameter created by the rotating blade around the sphere, is then approximately 2.5 inches. By choosing a feed tube 10 having a diameter (w) of about 2 inches, the depth of the shaped food product can be determined using the Pythagorean Theorem, to be approximately 0.50 inches. Comparing the 2.00 inch-diameter (w) of the outlet end 10b of the tube 10 to the depth 0.5 inches, we obtain one embodiment wherein a width to depth ratio of a food product is about 4:1. An example of a shaped food product produced with a ratio of about 4:1 utilizing a semi-circular blade in one embodiment is illustrated in FIG. 7. It will be appreciated that the symmetry of the products will be less defined after further processing steps eliminate moisture from the food product such as cooking, while the general scoop shape will remain intact. In another embodiment, the width or diameter (w) of the feed tube 10 is equal to about 2.5 inches, resulting in a width to depth ratio of 5:1.

A radius of the outlet end of a feed tube can be designed or adjusted to a specific measurement to be equal to or less than a blade length (B_{L}) or arc, which is the distance from the top of the curve blade to the bottom as seen in FIG. 6, to create chips having varying depths for uniform commercial production. The maximum possible width of a sliced food product is dependent on the inner cutter diameter (c), which is twice the length of the distance between the sphere center and the point along the interior of the blade furthest from the center of the sphere. One skilled in the art, armed with this disclosure, can easily see that other ratios are also possible by adjusting the area at the outlet end of the feed tube, using a sphere having another diameter or a blade with another inner cutter radius to create slices having width to depth ratios of between about 2:1 to about 8:1.

Unless otherwise indicated, all numbers expressing measurements, ranges, sizes and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Having thus described the present invention in some details by way of illustration and example, for purposes of clarity of understanding, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description is by way of example only.

What is claimed is:

1. A scoop cutter for the production of a shaped food product, comprising:
an arcuate blade secured to a thickness spacing sphere having an outer periphery, wherein said blade is in spaced relation to said outer periphery of said sphere and wherein said blade can rotate about said outer periphery.

2. The scoop cutter of claim 1, further comprising a feed tube having a diameter positioned at a non-parallel orientation to an axis of rotation of said thickness spacing sphere.

3. The scoop cutter of claim 2, wherein said feed tube further comprises a cylinder to force said at least one food product through a first end in said feed tube, thereby causing said food product to come into contact with said thickness spacing sphere.

4. The scoop cutter of claim 2, wherein the diameter of said feed tube determines a maximum width of said shaped food product.

5. The scoop cutter of claim 1, wherein said shaped food product has a width to depth ratio of about 4:1.

6. The scoop cutter of claim 1, wherein said shaped food product has a width to depth ratio of about 5:1.

7. The scoop cutter of claim 1, wherein said shaped food product has a width to depth ratio of between about 2:1 to about 8:1.

8. The scoop cutter of claim 1, wherein a distance between said blade and said sphere determines the thickness of said shaped food product.

9. The scoop cutter of claim 1, wherein said blade and said sphere are removably attached to a drive shaft.

10. The scoop cutter of claim 1, wherein said sphere comprises a diameter of between about 1 to about 4 inches.

11. The scoop cutter of claim 1, wherein said blade has a cutting edge on at least one side.

12. The scoop cutter of claim 1, further comprising a mounting base for support.

13. The scoop cutter of claim 1, wherein said blade is semi-circular.

14. The scoop cutter of claim 1, wherein said food product is scoop-shaped.

15. The scoop cutter apparatus of claim 1, wherein the food product is a fruit.

16. The scoop cutter of claim 1, wherein the food product is a vegetable.

17. The scoop cutter of claim 1, wherein the food product is a non-sticky dough comprising the ability to retain shape.

18. The food product made using the scoop cutter of claim 1.

19. A method for the production of a shaped food product, comprising:
a) forcing at least one food product against a thickness spacing sphere having an outer periphery, wherein said outer periphery is in spaced relation to an arcuate blade and wherein said sphere and blade form a scoop cutter; and
b) causing said arcuate blade to rotate about said outer periphery, thereby slicing said food product to produce shaped food products.

20. The method of claim 19, wherein said forcing step comprises placing said at least one food product through a feed tube having a diameter at an outlet end, wherein said feed tube is positioned at a non-parallel orientation to an axis of rotation of said thickness spacing sphere.

21. The method of claim 20, wherein said feed tube comprises a cylinder to force said at least one food product through a first end in the feed tube.

22. The method of claim 20, wherein the diameter of said feed tube determines a maximum width of the food product.

23. The method of claim 19, wherein step b) comprises removably attaching said blade and said sphere to a drive shaft.

24. The method of claim 23, further comprising attaching more than one scoop cutter to said drive shaft.

25. The method of claim 19, wherein steps a) and b) are performed simultaneously.

26. The method of claim 19, wherein said shaped food product has a width to depth ratio of about 4:1.

27. The method of claim 19, wherein said shaped food product has a width to depth ratio of about 5:1.

28. The method of claim 19, wherein said shaped food product has a width to depth ratio of about between about 2:1 to about 8:1.

29. The method of claim 19, wherein a distance between said blade and said sphere determines the thickness of said food product.

30. The method of claim 19, wherein the sphere has a diameter of between about 1 to 4 inches.

31. The method of claim 19, wherein said blade has a cutting edge on at least one side.

32. The method of claim 19, further comprising supporting said scoop cutter with a mounting base.

33. The method of claim 19, wherein said blade is semi-circular.

34. The method of claim 19, wherein said food product is scoop-shaped.

35. The method of claim 19, wherein the food product is a fruit.

36. The method of claim 19, wherein the food product is a vegetable.

37. The method of claim 19, wherein the food product is a non-sticky dough comprising the ability to retain shape.

38. The shaped food product made by the method of step 19.

39. The method of claim 19, further comprising processing said shaped food product into a ready-to-eat snack product.

40. The method of claim 19, further comprising processing said shaped food product into a frozen, par-fried food product.
